(19) United States
(12) Patent Application Publication
(10) Pub. No.: US 2008/0296248 A1
(43) Pub. Date: Dec. 4, 2008

(54) Method of Producing Plastic Tops for Sealed Containers of Pourable Food Products, and Container Plastic Tops So Produced

(75) Inventors: Paolo Benedetti, Modena (IT); Pietro Martini, Parma (IT)

Correspondence Address: BUCHANAN, INGERSOLL & ROONEY PC, POST OFFICE BOX 1404, ALEXANDRIA, VA, 22313-1404, US

(73) Assignee: TETRA LAVAL HOLDINGS & FINANCE S.A., Pully (CH)

(21) Appl. No.: 12/095,475

(22) PCT Filed: Nov. 30, 2006
(86) PCT No.: PCT/EP2006/069177

§ 371 Date: May 29, 2008

(30) Foreign Application Priority Data
Dec. 1, 2005 (EP) 05425856.1

(51) Int. Cl. B65D 39/00; B29C 65/00

(52) U.S. Cl. 215/252; 215/253; 156/196

(57) ABSTRACT

There is described a method of producing plastic tops (1) for sealed containers of pourable food products; the method starts with a plastic sheet material having a layer of gas-barrier material, and includes the steps of forming a contoured body (11) having an annular base portion (2, 12), and a neck portion (3, 13), which projects from the base portion (2, 12), defines, with the base portion, a pour opening (5) of the container, and is closed, on the opposite side to the base portion (2, 12), by a disk-shaped member (15); applying a cap (8) to the neck portion (3, 13); making a cut (16) along the periphery of the disk-shaped member (15) and on the side facing the pour opening (5); and joining the disk-shaped member (15), by adhesion, to a portion (10) of the cap (8) superimposed on the disk-shaped member, so that the disk-shaped member (15) defines a layer of gas-barrier material of the cap (8).

### TECHNICAL FIELD

The present invention relates to a method of producing plastic tops for sealed containers of pourable food products, and to container plastic tops so produced.

### BACKGROUND ART

As is known, many pourable food products, such as fruit juice, milk, tomato sauce, and beverages in general, are sold in a wide range of containers of different types and sizes, such as: parallelepiped-shaped packages made of multilayer, plastic- and/or paper-based, laminated materials or so-called multilayer cardboard materials; beaker-shaped plastic packages; blow-molded bottles; or glass, sheet metal or aluminium containers.

All these containers are fitted with opening devices to allow access by the consumer to the food product, either to pour it into a drinking vessel or consume it straight from the container.

Screw cap opening devices are commonly used on bottle-type containers, whereas containers made of multilayer cardboard materials are often simply provided with tear-off markers, or with pour openings formed in the containers and covered with pull tabs.

Containers made of multilayer cardboard materials are also known to be fitted with heat-seal plastic opening devices injection molded directly onto the containers, about openings formed through the packaging material, so as to completely close and seal the openings. Opening devices of this sort normally define the pour opening of the container, which may be fitted, for example, with a screw or snap cap.

Injection molded opening devices may of course be of various sizes and even define the whole top of the container, as in the case of the container known by the registered trademark “Tetra Top”, and the top of which is illustrated in Patent Application EP-A-0965531.

Though permitting precise, high-quality forming, injection molding container tops does not allow for integrating a layer of gas- and light-barrier material in the tops, as required, for example, when packaging vitamin-supplemented fruit juice.

As described, for example, in Patent EP-B-1197438 and Patent Application WO 03/061940, plastic tops of containers are also known to be produced by blowing a plastic tubular perform, which may include a layer of gas- and light-barrier material.

The container known by the trademark “Tetra Aptiva” is one example of a container produced using this technique, i.e. having a main bottom portion made of multilayer cardboard material, and a top, for pouring the liquid or pourable product in the container, produced by blowing a plastic tubular perform.

This technique provides for a high degree of forming precision, especially as regards the pour opening, but has the drawbacks of being extremely slow and of requiring the use of special-purpose equipment.

To produce plastic tops to be applied to the container portion of multilayer cardboard material, a method has recently been devised comprising thermoforming and injection molding operations, but no blowing.

One example of this method is described in Patent Application WO 2005/044538, and comprises the step of thermoforming a sheet body of multilayer plastic material having a layer of gas-barrier material, e.g. EVOH. The body is defined integrally by an annular base portion, which is eventually fitted to the cardboard bottom portion of the container; and by a cylindrical neck portion projecting from the inner edge of the base portion and defining, with the base portion, a pour opening by which to pour out the food product. Since thermoforming is performed starting from a sheet of plastic material, the neck portion is closed on the opposite side to that from which the base portion extends. A protective outer layer of plastic material, with a lateral thread to screw on a cap, is injection molded onto the sheet body so formed.

After the above operations, and before applying the cap, the plastic material closing the pour opening is removed.

As is known, the caps used to close the various types of containers described above are normally made of plastic material enabling the caps to be fitted to and removed from the containers easily, and also detached easily, when unsealing the caps, from tamperproof rings, to which they are normally connected by break-off connecting members.

Commonly used materials with the above properties, such as polyethylene and polypropylene, however, fail to provide an effective gas barrier, so the side of the cap facing inwards of the pour opening, in use, must be fitted with an additional disk-shaped member of gas-barrier material known in the trade as a “liner”.

The above method of producing plastic tops for combined cardboard-plastic containers therefore involves a good deal of time, work, and waste in material.

In fact, the portion of material closing the pour opening after the thermoforming operation, and which is removed before applying the cap, normally amounts to about 15-20% of the starting material.

Moreover, the liner inserted inside the cap constitutes an additional member, which must be produced and fitted to the cap before the cap is applied to the container.

### DISCLOSURE OF INVENTION

It is an object of the present invention to provide a method of producing plastic tops for sealed containers of pourable food products, designed to eliminate the aforementioned drawbacks in a straightforward, low-cost manner.

According to the present invention, there is provided a method of producing plastic tops for sealed containers of pourable food products, said method comprising the steps of:
forming a contoured body from a plastic sheet material having a layer of gas-barrier material, said contoured body comprising an annular base portion, and a neck portion, which projects from said base portion, defines, with the base portion, a pour opening of said container, and is closed, on the opposite side to said base portion, by a disk-shaped member; and
applying a cap to said neck portion;

and being characterized by comprising the further steps of:
making a cut along the periphery of said disk-shaped member and on the side facing said pour opening; and
joining said disk-shaped member, by adhesion, to a portion of said cap superimposed on the disk-shaped member, so that said disk-shaped member defines a layer of gas-barrier material of the cap.

The present invention also relates to a plastic top for sealed containers of pourable food products, said top comprising:
an annular base portion;
a neck portion projecting from said base portion, defining, with the base portion, a pour opening of said container, and closed, on the opposite side to said base portion, by a disk-shaped member; and
a cap applied to said neck portion;

and being characterized in that said disk-shaped member has a cut along its outer periphery and on the side facing said pour opening; and in that said disk-shaped member is joined to a portion of said cap superimposed on the disk-shaped member, so that said disk-shaped member defines a layer of gas-barrier material of the cap.

### BRIEF DESCRIPTION OF THE DRAWINGS

A preferred, non-limiting embodiment of the present invention will be described by way of example with reference to the accompanying drawings, in which:

FIGS. 1 to 5 show vertical sections of a plastic top, for sealed containers of pourable food products, at the various stages in the method according to the present invention;

FIG. 6 shows a larger-scale vertical section of a detail of FIG. 4;

FIG. 7 shows a vertical section of the FIG. 1-5 plastic top after the container is opened.

### BEST MODE FOR CARRYING OUT THE INVENTION

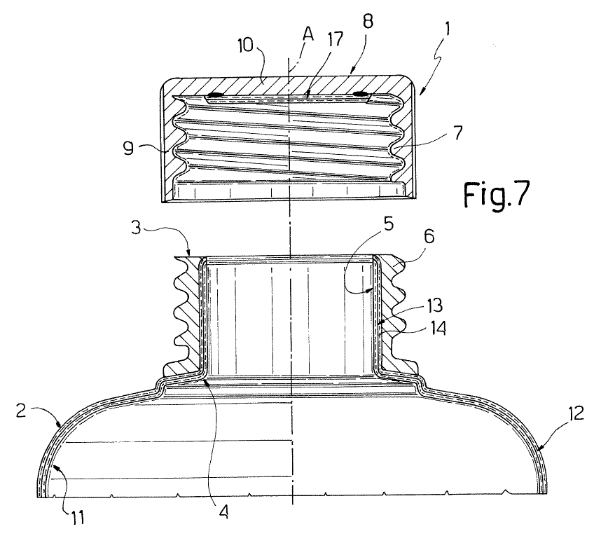

Number 1 in FIGS. 5 and 7 indicates as a whole a plastic top for a container (not shown) of liquid or pourable food products, such as a combined cardboard-plastic container—to which the following description refers purely by way of example—or a plastic bottle.

Top 1 has a longitudinal axis A, and comprises an annular base portion 2, which, in the example shown, is concave inwards of the container; and a substantially cylindrical tubular neck portion 3, which projects from an inner radial edge 4 of base portion 2, and defines, with base portion 2, a pour opening 5 by which to pour the food product out of the container.

More specifically, neck portion 3 has, along its outer lateral surface, a thread 6 for engaging a complementary thread 7 of a cylindrical cap 8.

Cap 8 is substantially defined by a cylindrical lateral wall 9 having thread 7 inside; and by a disk-shaped top wall 10 for closing, in use, the top of pour opening 5.

Top 1 is produced according to the method described below.

Firstly, a forming operation, preferably a thermoforming or hot forming operation, is performed on a multilayer plastic sheet material comprising a layer of gas-barrier material, e.g. EVOH.

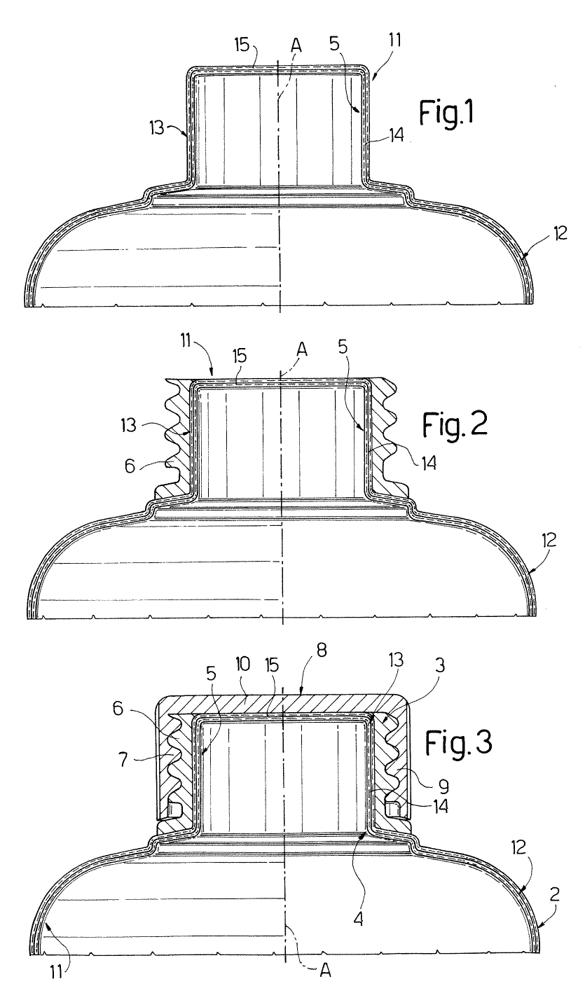

The forming operation produces a hollow, substantially hat-shaped body 11 (FIG. 1), which is open on the side facing the container to which it is eventually applied, and is closed on the opposite side.

More specifically, body 11 comprises an annular bottom portion 12 integrally defining base portion 2; and an inverted cylindrical cup-shaped top portion 13 projecting axially from the inner radial edge of bottom portion 12. Top portion 13 has a lateral wall 14 defining the inner side of neck portion 3, and therefore laterally bounding pour opening 5; and a disk-shaped top wall 15 closing pour opening 5.

Next (FIG. 2), plastic material is injection molded onto the outer side of lateral wall 14 of top portion 13 of body 11 to form thread 6.

The injected material may be defined, for example, by polyethylene or polypropylene or polyolefin.

At this point (FIG. 3), cap 8 is applied to the body so formed, so that threads 6 and 7 engage mutually, and top wall 10 of cap 8 is positioned adjacent to, or rather superimposed on, disk-shaped top wall 15 of body 11.

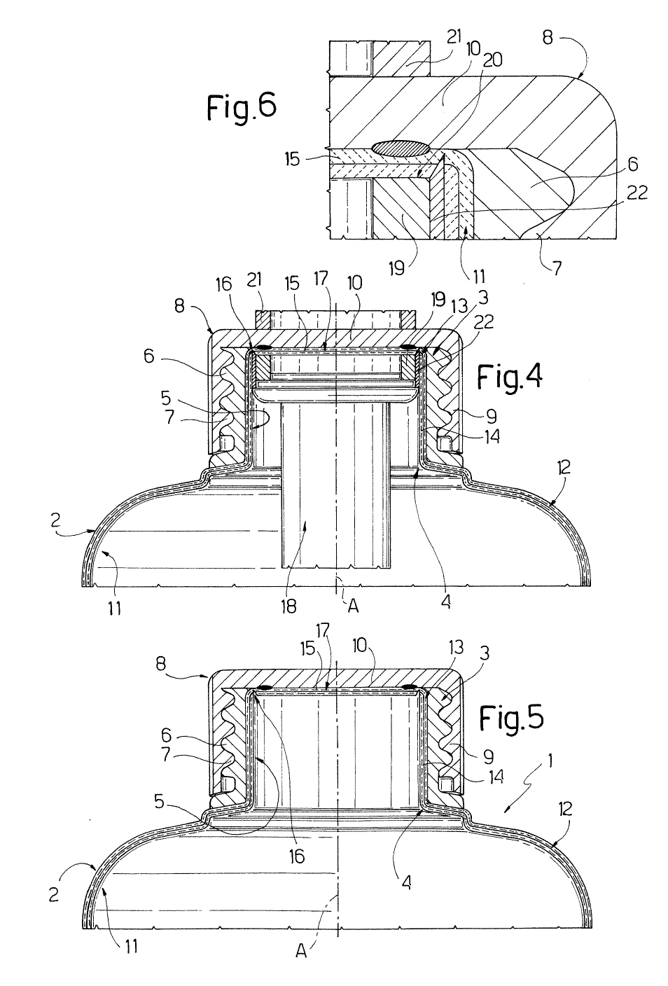

Advantageously, top wall 10 of cap 8 and top wall 15 of body 11 are joined, e.g. by ultrasonic welding, along at least their outer periphery; and an annular cut 16 is made on top wall 15 of body 11, on the side facing pour opening 5 (FIGS. 4 and 6).

Top wall 15 of body 11 thus defines a layer 17 of gas-barrier material of cap 8, i.e. a “liner”, as this layer is commonly referred to in the packaging of pourable food products.

As shown in FIGS. 4 and 6, the ultrasonic welding operation and the formation of cut 16 are performed simultaneously by a device 18, which substantially comprises a substantially cylindrical tubular pressure member 19 having an annular work surface 20 cooperating with top wall 15 of body 11, and an ultrasound generating unit (not shown); a backup member 21 cooperating with top wall 10 of cap 8 on the opposite side to pressure member 19; and guide means (not shown) for moving pressure member 19 to and from backup member 21 to obtain the desired compression force during ultrasound generation.

The outer periphery of pressure member 19 is fitted with a cutting member 22 which acts on top wall 15 to make cut 16.

When unsealing the container (FIG. 7), unscrewing cap 8 detaches top wall 15 from body 11, by virtue of cut 16; and, as opposed to being discarded, wall 15 remains attached to top wall 10 of cap 8, by virtue of the weld.

The advantages of the method and of top 1 according to the teachings of the present invention will be clear from the foregoing description.

In particular, the liner of cap 8 need no longer be produced separately, and is simply obtained from top wall 15 of body 11 produced by means of a forming operation. On the one hand, this provides for eliminating any waste in material, and on the other, makes the method of producing container tops 1 extremely fast and straightforward.

Clearly, changes may be made to the method and top 1 as described and illustrated herein without, however, departing from the scope as defined in the accompanying Claims.

1. A method of producing plastic tops for sealed containers of pourable food products, said method comprising:
forming a contoured body from a plastic sheet material having a layer of gas-barrier material, said contoured body comprising an annular base portion, and a neck portion, which projects from said base portion, defines, with the base portion, a pour opening of said container, and is closed, on a side opposite to said base portion, by a disk-shaped member;
applying a cap to said neck portion;
making a cut along a periphery of said disk-shaped member and on a side facing said pour opening; and
joining said disk-shaped member, by adhesion, to a portion of said cap superimposed on the disk-shaped member, so that said disk-shaped member defines a layer of gas-barrier material of the cap.

2. A method as claimed in claim 1, wherein said forming of the contoured body comprises hot-forming the contoured body.

3. A method as claimed in claim 1, further comprising injection molding a thread on said neck portion of said contoured body, on a side opposite to a side bounding said pour opening; said cap having an internal thread which engages said thread of said neck portion.

4. A method as claimed in claim 1, wherein said joining by adhesion is an induction welding step.

5. A method as claimed in claim 1, wherein said joining by adhesion is performed close to a peripheral edge of said disk-shaped member.

6. A plastic top for sealed containers of pourable food products, said top comprising:
an annular base portion;
a neck portion projecting from said base portion, defining, with the base portion, a pour opening of said container, and closed, on a side opposite to said base portion, by a disk-shaped member; and
a cap applied to said neck portion;
wherein said disk-shaped member has a cut along its outer periphery and on a side facing said pour openings; and
wherein said disk-shaped member is joined to a portion of said cap superimposed on the disk-shaped member, so that said disk-shaped member defines a layer of gas-barrier material of the cap.

7. A top as claimed in claim 6, wherein said neck portion and the cap have an external and internal thread respectively, which engage one another in the closed position of the cap.

8. A top as claimed in claim 7, wherein said cap comprises a cylindrical lateral wall having the internal thread inside; and a top wall which, in use, closes a top of said pour opening and is joined to said disk-shaped member.
